(19) United States
(12) Patent Application Publication
(10) Pub. No.: US 2017/0064507 A1
(43) Pub. Date: Mar. 2, 2017

(54) PLANT DIAGNOSTIC AND LOCATION DETECTION MEANS AND SYSTEM

(71) Applicant: Geoshepard, Inc., Castle Pines, CO (US)

(72) Inventors: Dennis Lee Lineberry, Castle Pines, CO (US); Jay Lineberry, Highlands Ranch, CO (US)

(73) Assignee: GeoShephard, Inc., Castle Pines, CO (US)

(21) Appl. No.: 15/250,844

(22) Filed: Aug. 29, 2016

Related U.S. Application Data
(60) Provisional application No. 62/210,951, filed on Aug. 27, 2015.

(51) Int. Cl. H04W 4/02

(52) U.S. Cl. CPC H04W 4/023

(57) ABSTRACT

A system and method of tracking of the location and environmental status conditions of plants or plant parts in a greenhouse or other growing area is automatically transmitted wirelessly to a central processor through a hub which can calculate the current location of the plants. The system can be used for compliance of heavily regulated plants, such as cannabis plants. Environmental status conditions may include temperature, humidity, lumens, altitude, soil moisture, barometric pressure, air wind speed and movement velocity.

### CROSS REFERENCE TO REFERENCE TO RELATED APPLICATIONS

This application claims the benefit of U.S. Provisional Patent Application 62/210,951 entitled “Cannabis Diagnostic and Location Detection Means” filed on Aug. 27, 2015, the entire contents of which are incorporated herein by reference in its entirety for all purposes.

### FIELD OF THE INVENTION

The present invention is directed to a system and method of tracking of the location and environmental status conditions of plants or plant parts in a greenhouse or other growing area is automatically transmitted wirelessly to a central processor through a hub which can calculate the current location of the plants. The system can be used for compliance of heavily regulated plants, such as cannabis plants. Environmental status conditions may include temperature, humidity, lumens, altitude, soil moisture, barometric pressure, air wind speed and movement velocity.

The present invention relates to the field of plant tracking, such as cannabis plant tracking using wireless technology. More specifically, the present invention relates to the use of a wireless communication enabled tags (“wireless tags”) paired with a specific plant to track the location and environmental surroundings of the plant. The tracking of a plant is performed within the range of influence of a wireless communication enabled receiving hub (“wireless hub”) or related central control point.

### BACKGROUND OF THE INVENTION

The production of certain plants, such as cannabis plants, require in-depth knowledge of the plant's location, environment as well as the statistics surrounding such plants. These plants may be high-value or high-maintenance plants such as orchids or highly regulated plants such as cannabis based plants, including industrial hemp. Regulations surrounding growing highly regulated plants sometimes requires data for each individual plant including data points at the time of harvest including, but not limited to: weight of trimmings, dehydrated weight of trimmings, water weight, discarded material weight, and final product weight.

The regulations surrounding highly regulated plants hold cultivators of plants accountable for the tracking of each individual plant specimen as well as all data points surrounding the growth of such plants from seed to harvest and to sale. As a result of heavy and sometimes complicated regulations surrounding some plants, such as cannabis plants, the time and effort required for the collection and maintenance of this data and data collection is burdensome on cultivators.

There exists a need for the automation and more efficient collection and maintenance of data surrounding the growth of heavily regulated plants, high value plants and other plants requiring high levels of data collection and tracking. For example, each governing entity that engages in the regulation of cannabis plants, require compliance with a set of regulations developed by that governing body. For instance, the state of Colorado has in place a set of regulations for accounting of the growth, harvesting, transportation and sale of cannabis plants. Furthermore, the state of Colorado has a separate set of regulations surrounding cannabis plants intended for medicinal use or recreational use adding further complexity to the accounting of details surrounding the growth, harvesting, transportation and sale of cannabis plants.

The State of Colorado for instance requires reported accounting of cannabis plants grown for medicinal sale and retail sale to include from seed to harvest. The State of Colorado also requires the use of barcodes or RFID tags for tracking and accounting which must be associated with individual plants, plant parts, or package following harvest, cultivators must provide reported accounting for post-harvested and packaged cannabis plant parts including the transportation of, inventory of each transported delivery from harvest and processing location to a location for sale. Furthermore, when packaged cannabis plant parts are transported, accounting of the planned and actual transportation route of a delivery from a harvest and processing location to a location for sale must be reported.

### SUMMARY OF THE INVENTION

The invention as disclosed in this application, surrounds a system and method of for the data collection and tracking of plants in a growing, harvesting and processing environment. The data recorded and stored by such a system and method may be used for compliance with regulations, increasing the productivity of a crop yield surrounding particular plants or other uses recognized by those skilled in the art.

Certain embodiments of the invention as disclosed herein collect and record data including, but not limited to, cannabis plant location, localized environmental status, and location associated with individual plants, groups of plants or plant parts. It will be appreciated that environmental status may include, but is not limited to temperature, humidity, lighting levels, altitude, soil moisture levels, barometric pressure, air wind speed, movement and movement velocity data. The movement or movement velocity of an individual plant may be used to indicate the unauthorized handling or theft of a plant which is being tracked. For instance, if there is movement or movement velocity detected during a time period when such movement is not expected, this may serve to indicate the unauthorized handling or theft.

Certain embodiments of the invention as described herein use wireless tags affixed to an individual plant to track data associated with the individual plant. In other embodiments, a wireless tag may be associated with a plurality of plants to provide data collection and tracking information for more than one plant. In other embodiments, a wireless tag may be associated with plant parts.

Certain embodiments of the invention as discussed herein surround the use of aggregated data collected from a plurality of plants by wireless tags to provide general data across a broad area, such as the floor plan of a growing facility. For instance, the temperature data, location data and other data associated with individual plants throughout a growing facility may be used to generate a thermal heat map of an entire facility. Furthermore, such aggregation of data may allow a cultivator to determine localized thermal inconsistencies and how it may affect plants positively or negatively through their life-cycle.

In certain embodiments of the present invention, as individual plants, groups of plants or plant parts are moved throughout a growing facility or outdoor growing area, data relating to the current location and environmental status, may be updated with the use of wireless tags associated with and attached to individual plants, groups of plants or plant parts. These wireless tags wirelessly communicate with wireless hubs to communicate location and environmental status. The wireless hubs, communicate the received data with a central processor which calculates location, stores environmental data and further transmits collected data and calculated information to a database. It will be appreciated to those skilled in the art that a wireless hub is a communication device using wireless communication protocol to send and/or receive data. Such wireless communication protocols may include, but are not limited to, Bluetooth®, radio, light waves, or other means of wireless communication known to those skilled in the art.

An embodiment of the present invention surrounds a method for locating the position and determining the environmental status of a plant, a plurality of plants or plant parts. It is an objective of the method provide wireless automation of the tracking system of the present invention to locate and identify the environmental status of plants, or plant parts. It is a further objective of such an embodiment to manage location data and environmental status data relating to plants and plant parts as they move throughout a grow facility or outdoor facility.

Certain embodiments of a method of use surrounding a system for tracking plants uses a plurality of wireless hubs to use triangulation processes to determine and track the location of a wirelessly enabled identification tag associated with a plant. It will be appreciated that such methods of locating and tracking may be applied to packaged plant parts to track movements such as transportation from a harvest area to an area for retail or medicinal sale.

Embodiments of the present invention provide solutions to the required regulations of governing bodies, such as the State of Colorado, which require detailed accounting of steps that may include, but are not limited to the growth, harvest, packaging and delivery of cannabis plants and cannabis plant parts. Certain embodiments of the invention as disclosed provides the ability to associate a Bluetooth® enabled wireless tag associated with a cannabis plant with a state provided barcode or RFID tag. As a result, reports surrounding the tracked information, location, and environmental status of an associated cannabis plant may be automatically generated and reported to the governing body.

Certain embodiments of the present invention comprise an application for the communication with a central processor and a database. In certain embodiments, a mobile communication device with the application with bar-code scanning and Bluetooth® capability may be used to associate a wireless with an identifying tag such as a barcode or RFID enabled tag. In such embodiments, a user may use a mobile device with an application installed to interact with a wireless tag. In certain embodiments, the mobile device comprises RFID scanning or barcode reading ability and Bluetooth® capability. In such embodiments a user may scan the RFID or barcode, and based on proximity and strength of Bluetooth® signal, the application pairs the identifying tag with the wireless tag. Once this information is paired, the application transmits the paired information through the mobile device to a central processor to be recorded in a database. Alternatively, the application may transmit the paired information directly to a database.

Certain embodiments of the present invention comprise an application for the communication with a scale for the measurement of weight of a cannabis plant or cannabis plant parts. In certain embodiments the application is installed on a mobile device such as a smart phone, tablet or computer. A wireless tag associated with the cannabis plant or cannabis plant parts is recognized through Bluetooth® capability of the mobile device. The scale is being used to measure the weight of a cannabis plant or cannabis plant parts and the weight is recorded in the application. The weight information is paired with the wireless tag information and transmitted to a central processor for recording. Alternatively, the application may transmit the paired information directly to a database.

Certain embodiments of the present invention comprises an application for the communication of a plurality of wireless tags for the purposes of generating a report surrounding the transportation of cannabis plants or cannabis plant parts. The application, installed on a mobile device communicates with wireless tags associated with the cannabis plants or cannabis plant parts being transported. The application also tracks, via GPS sensors, the location of the transportation vehicle. The application generates a transportation manifest comprising the identification information of all cannabis plants or cannabis plant parts carried by the vehicle. The application then sends the transportation manifest and location information using the mobile device, to a central processor or database for recording. The application may also send the transportation manifest and location information in real-time or upon completion to a regulating entity such as the state of Colorado in compliance with regulations such as 1 Code Colo. Regs. §212-1 or 1 Code Colo. Regs. §212-2.

It will be appreciated that a central processor may also be used to send the transportation manifest and location information to a regulating entity.

Certain embodiments of a plant diagnostic location and detection means comprise wireless tags that transmit information to wireless hubs on predetermined intervals. In certain embodiments, a wireless tag may transmit information when environmental status changes.

These and other advantages will be apparent from the disclosure of the invention(s) contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should it be construed as being representative of the full extent and scope of the present invention. The present invention is set forth in various levels of detail in this Summary, as well as in the attached drawings and the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings and the exemplary Claims.

### BRIEF DESCRIPTION OF THE DRAWINGS

FIG. 1—A certain embodiment of a plant location and diagnostic detection system for the tracking of individual plants

FIG. 2—A certain embodiment of a plant location and diagnostic detection system for the tracking of groups of plants

FIG. 3—A certain embodiment of a plant location and diagnostic detection system

### DETAILED DESCRIPTION OF VARIOUS EMBODIMENTS

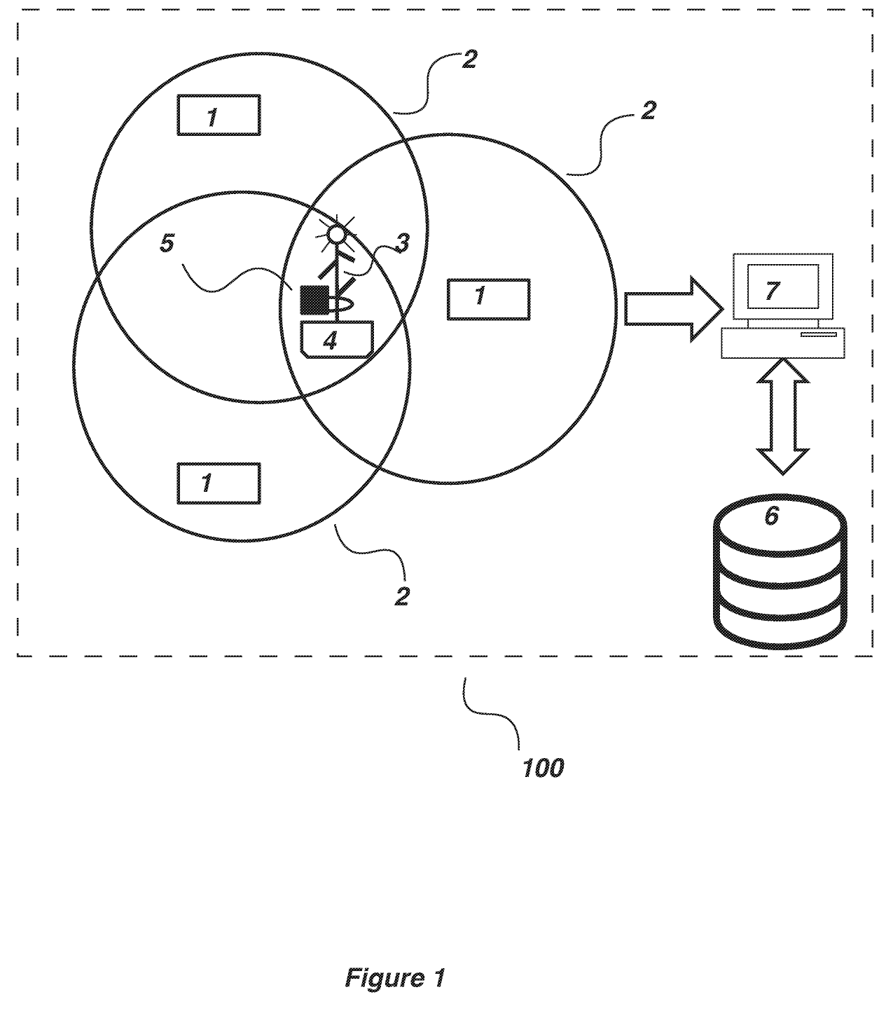

Certain embodiments of the present invention comprise a plant diagnostic and location detection system 100, as seen in FIG. 1, use a wireless hub 1 capable of automatically detecting and transmitting wireless data. Certain embodiments such as the embodiment shown in FIG. 1 may use three wireless hubs 1, other embodiments may use as few as one wireless hub 1, while other embodiments may use a plurality of wireless hubs 1 of quantity greater than three. Each wireless hub 1, comprises a power supply and module for receiving and transmitting data both wirelessly and via wired communication protocol. It will be appreciated that wireless hubs 1, can detect the presence of a wireless tag 5 within a wireless signal radius 2. In certain embodiments, a wireless tag 5 is attached to a cannabis plant 3. It will be appreciated that a portion of a wireless tag 5 that is able to sense soil moisture may be inserted into the soil of pot 4 within which the cannabis plant 3 is planted. Certain embodiments of a wireless tag 5 comprise a wireless transmitter interconnected with sensors for recording environmental status such as, but not limited to, temperature, humidity, light intensity, altitude, soil moisture, barometric pressure, wind speed, acceleration and velocity. Certain embodiments of a wireless tag 5 comprise a power supply such as a battery. It will be appreciated by those skilled in the art that wireless transmission between a wireless tag 5 and at least one hub 1 may be achieved via Bluetooth®, radio frequency transmission, lightwave transmission, or other existing wireless communication protocol known to those skilled in the art.

Referring again to FIG. 1, it will be appreciated that in order to determine the location of a wireless tag 5, the wireless tag 5 must be within the wireless signal radius 2 of at least two wireless hubs 1. It will be appreciated that for the purposes of triangulation, in some scenarios it is preferred that a wireless tag 5 be located within the wireless signal radius 2 of three or more wireless hubs 1. It will be appreciated by those skilled in the art that triangulation using wireless transmitters and wireless receivers may be accomplished using a variety of different strategies. Such strategies include, but are not limited to received signal strength indication (RSSI), fingerprinting, angle of arrival (AoA) and time of flight (ToF) based techniques. The triangulation of the location of a wireless tag 5 may be performed when the wireless tag 5 is within the wireless signal radius 2 of a plurality of wireless hubs 1 having overlapping wireless signal radii. In such embodiments, the transmission from a wireless tag 5 to a plurality of wireless hubs 1 comprises information needed to determine the location of the cannabis plant 3 to which the wireless tag 5 is associated with. The transmission from a wireless tag 5 to at least one wireless hub 1 may also comprise information pertaining to the environmental status of the cannabis plant 3. Furthermore, a wireless tag 5 may transmit self-diagnostic information such as battery level. Information that is sent from a wireless tag 5 to a wireless hub 1 is then transmitted to a central processor 7 which stores received information in a database. The central processor 7 performs determines the location of a wireless tag 5 and records it in the database 6. The central processor 7 may compare received information with previously received information stored in a database 6. It will be appreciated to those skilled in the art that a database 6 as discussed herein may comprise memory storage internal to the central processor 7, memory storage external to the central processor 7, or a cloud based memory storage.

In certain embodiments, if a cannabis plant 3 is moved, a change in the signal strength transmitted from wireless tag 5 to a wireless hub 1 changes. This may indicate the movement of a cannabis plant 3. Furthermore, the sudden loss of wireless transmission from a wireless tag 5 to a hub 1, may indicate the loss of the wireless tag 5 or removal of a cannabis plant 3, to which the wireless tag is associated with. In certain embodiments, when a central processor 7 identifies a change in environmental status of a cannabis plant 3 or location of a wireless tag 5, the central processor 7 may generate a notification.

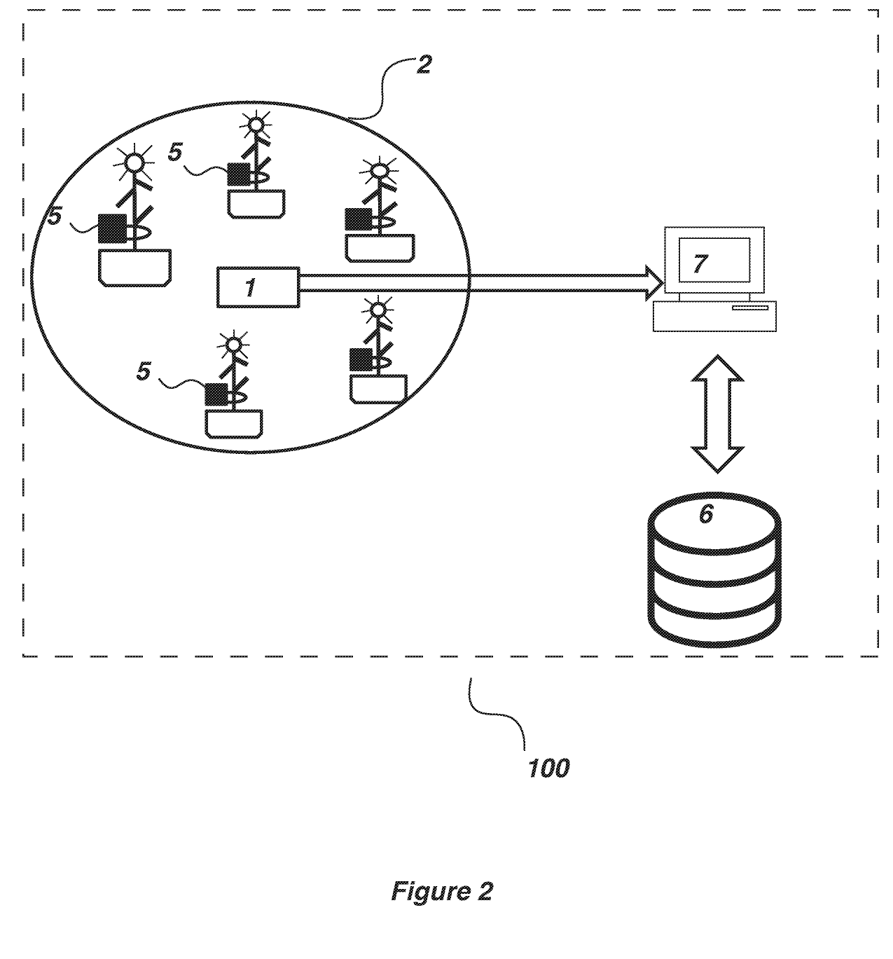

Certain embodiments of a plant diagnostic and location detection system 100, as seen in FIG. 2, uses a singular wireless hub 1 located in proximity to a plurality of cannabis plants 3 for receiving and transmitting wireless data. A plurality of wireless tags 5 may automatically and wirelessly transmit environmental status data to the hub 1. The hub 1, of known location, receives wireless transmissions from within limited wireless signal radius. When the information received by the wireless hub 1 is transmitted to the central processor 7, the location of certain cannabis plants 3 may be determined using the predetermined location of the wireless hub 1 as well as the signal strength detected between the wireless hub 1 and said cannabis plants 3. Location data shall be calculated using the signal strength metric as derived from the signal received by hub 1 received from a wireless tag 5 by and wireless hub 1. The hub 1 transmits both location and environmental status data to a central processor 7 for the processing of data, generation and delivery of notifications. Furthermore, the central processor 7 transmits data to a database 6.

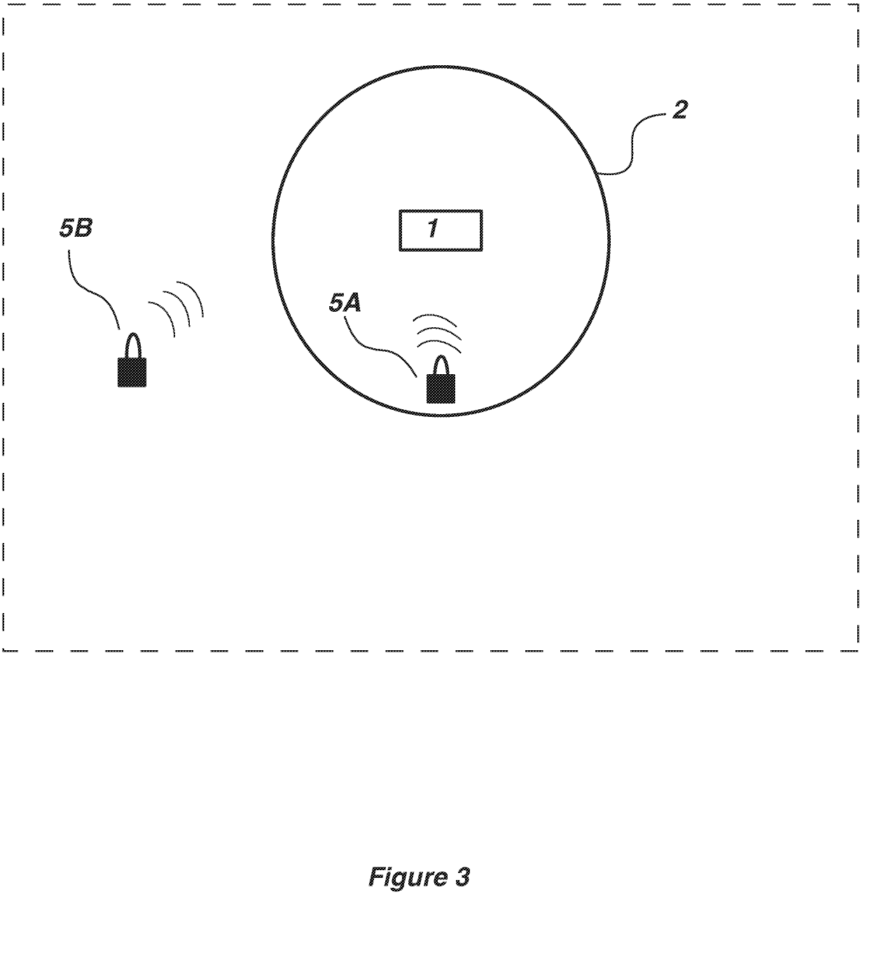

Certain embodiments of a plant diagnostic and location detection system 100, seen in FIG. 3, comprise a wireless hub 1 and a wireless tag 5. If a first wireless tag 5 is within a wireless signal radius 2 of the wireless hub 1, the first wireless tag 5 communicates wirelessly with the wireless hub 1. A second wireless tag 5 outside the wireless signal radius 2 of the wireless hub 1, will not communicate with the wireless hub 1. The second wireless tag 5 that is outside the wireless signal radius 2 of a wireless hub 1, however, will continue to wirelessly transmit information. It will be determined that if a hub 1 does not receive transmission from a wireless tag 5, that the wireless tag 5 is outside the wireless signal radius 2 of the wireless hub 1.

Certain embodiments of the present invention comprise attaching a wireless tag to a cannabis plant. The wireless tag senses and records information such as environmental status information. The wireless tag transmits information to a wireless hub. The wireless hub receives the information from the wireless tag. The wireless hub then transmits the received information from the wireless tag to a central processor. The central processor receives the data sent from the wireless hub and stores it in a database. The central processor performs analysis on the information received from the wireless hub to determine location of the cannabis plant using a triangulation strategy. The central processor then displays the cannabis plant location and environmental status of the cannabis plant on a user interface. The central processor may also compare the environmental status received with previously received environmental status stored in the database. In certain embodiments the central processor compares information previously received from a wireless tag. If information is not received from a wireless tag within a predetermined time period, the central computer generates and transmits an alert. Alerts may be displayed on a user interface or sent to an authorized user through means of email, short message service (SMS), or other communication means appreciated by those skilled in the art. In certain embodiments, a central processor issues an alert if information received indicates a wireless tag has a battery level below a predetermined threshold. A central processor may also issue an alert of the environmental status data of one or more cannabis plants are determined to be outside a predetermined range. Certain embodiments sensing the temperatures surrounding a cannabis plant have a predetermined temperature range from 21.1-degrees Celsius (70-degrees Fahrenheit) to 24.4-degrees Celsius (74-degrees Fahrenheit.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the spirit or central characteristics thereof. The present examples and embodiments, therefore, are to be considered in all respects as illustrative and not restrictive, and the invention is not to be limited to the details given herein. The terms “first,” “second,” “top,” “bottom,” etc., as used herein, are intended for illustrative purposes only and do not limit the embodiments in any way. Additionally, the term “plurality,” as used herein, indicates any number greater than one, either disjunctively or conjunctively, as necessary, up to an infinite number. Further, “Providing” an article or apparatus, as used herein, refers broadly to making the article available or accessible for future actions to be performed on the article, and does not connote that the party providing the article has manufactured, produced, or supplied the article or that the party providing the article has ownership or control of the article. Accordingly, while specific embodiments have been illustrated and described, numerous modifications come to mind without significantly departing from the spirit of the invention and the scope of protection is only limited by the scope of the accompanying Claims.

What is claimed is:

1. A method for discerning the location and environmental status of plants or plant parts comprising:
attaching a wireless tag to a plant;
sensing information surrounding said plant;
transmitting said information from said wireless tag to a first wireless hub;
transmitting said information from said wireless tag to a second wireless hub;
transmitting said information from said first wireless hub and said second wireless hub to a central processor;
determining the relative location of said plant from said first wireless hub using said information transmitted from said wireless tag to said first wireless hub;
determining the relative location of said plant from said second wireless hub using said information transmitted from said wireless tag to said second wireless hub;
triangulating a location of said plant using the relative location of said plant from said first wireless hub and said second wireless hub;
recording said location to a database; and
displaying said location on a user interface.

2. The method of claim 1 further comprising:
sensing an environmental status of said plant;
transmitting said environmental status of said plant to said first wireless hub;
transmitting said environmental status of said plant to said central processor;
recording said environmental status of said plant in said database; and
displaying said environmental status of said plant on a user interface.

3. The method of claim 2 further comprising:
comparing said environmental status to previously recorded environmental status of said plant; and
displaying any change in environmental status of said plant on said user interface.

4. The method of claim 2 further comprising:
generating an alert if said environmental status are not within a predetermined threshold.

5. The method of claim 2 further comprising:
sensing changes in environmental status by said wireless tag; and
transmitting information from said wireless tag to said first wireless hub or said second wireless hub if said wireless tag senses a change in environmental status.

6. The method of claim 1, further comprising:
generating an alert if said wireless tag stops transmitting to said first wireless hub or said second wireless hub.

7. The method of claim 1, further comprising:
transmitting wireless tag status comprising battery level information to said first wireless hub;
transmitting said wireless tag status from said first wireless hub to said central processor; and
generating an alert if said battery level information is not within a predetermined threshold.

8. The method of claim 1, further comprising:
generating an inventory report.

9. The method of claim 1 wherein the step of transmitting information from said wireless tag to said first wireless hub and said second wireless hub occurs at predetermined time intervals.

10. The method of claim 1 further comprising:
detecting a signal strength between said first wireless hub and said wireless tag;
transmitting said signal strength between said first wireless hub and said wireless tag to said central processor; and
detecting a signal strength between said second wireless hub and said wireless tag;
transmitting said signal strength between said second wireless hub and said wireless tag to said central processor.

11. The method of claim 10, wherein the step of determining the relative location of said plant from said first wireless hub is calculated using said signal strength between said wireless tag and said first wireless hub; and
the step of determining the relative location of said plant from said second wireless hub is calculated using signal strength between said wireless tag and said first wireless hub
and said second wireless tag is calculated using signal strength.

12. The method of claim 1, wherein said steps of transmitting information from said wireless tag to said first wireless hub or said second wireless hub is performed via wireless transmission means selected from the group comprising Bluetooth®, 802.11 wireless transmission, or a mobile phone network.
